(19) United States
(12) Patent Application Publication
(10) Pub. No.: US 2008/0315101 A1
(43) Pub. Date: Dec. 25, 2008

(54) DIAMOND-LIKE CARBON INFRARED DETECTOR AND ASSOCIATED METHODS

(76) Inventors: Chien-Min Sung, Tansui (TW); Michael Sung, San Franciso, CA (US)

Correspondence Address: THORPE NORTH & WESTERN, LLP., P.O. Box 1219, SANDY, UT, 84091-1219, US

(21) Appl. No.: 11/765,934

(22) Filed: Jun. 20, 2007

(51) Int. Cl. G01J 5/10; G01J 5/20

(52) U.S. Cl. 250/338.4; 250/338.1; 250/341.1; 250/349

(57) ABSTRACT

Diamond-like carbon based energy conversion devices and methods of making and using the same are disclosed. Such devices may include a surface for detection of infrared photons. Such a surface may include at least one metal cone and a diamond-like carbon layer disposed on the at least one metal cone. The at least one diamond-like carbon-coated metal cone is thus configured to receive infrared photons and generate electrons therefrom. In another aspect, the at least one metal cone may be an array of electronically coupled metal cones.

### FIELD OF THE INVENTION

The present invention relates generally to devices and methods for detecting infrared energy using diamond-like carbon materials. Accordingly, the present application involves the fields of physics, chemistry, electricity, and material science.

### BACKGROUND OF THE INVENTION

Thermionic and field emission devices are well known and used in a variety of applications. Field emission devices such as cathode ray tubes and field emission displays are common examples of such devices. Generally, thermionic electron emission devices operate by ejecting hot electrons over a potential barrier, while field emission devices operate by causing electrons to tunnel through a barrier. Examples of specific devices include those disclosed in U.S. Pat. Nos. 6,229,083; 6,204,595; 6,103,298; 6,064,137; 6,055,815; 6,039,471; 5,994,638; 5,984,752; 5,981,071; 5,874,039; 5,777,427; 5,722,242; 5,713,775; 5,712,488; 5,675,972; and 5,562,781, each of which is incorporated herein by reference.

The electron emission properties of thermionic devices are more highly temperature dependent than in field emission devices. An increase in temperature can dramatically affect the number of electrons which are emitted from thermionic device surfaces.

Although basically successful in many applications, thermionic devices have been less successful than field emission devices, as field emission devices generally achieve a higher current output. Despite this key advantage, most field emission devices suffer from a variety of other shortcomings that limit their potential uses, including materials limitations, versatility limitations, cost effectiveness, lifespan limitations, and efficiency limitations, among others.

A variety of different materials have been used in field emitters in an effort to remedy the above-recited shortcomings, and to achieve higher current outputs using lower energy inputs. One material that has recently become of significant interest for its physical properties is diamond. Specifically, pure diamond has a low positive electron affinity which is close to vacuum. Similarly, diamond doped with a low ionization potential element, such as cesium, has a negative electron affinity (NEA) that allows electrons held in its orbitals to be shaken therefrom with minimal energy input. However, diamond also has a high band gap that makes it an insulator and prevents electrons from moving through, or out of it. A number of attempts have been made to modify or lower the band gap, such as doping the diamond with a variety of dopants, and forming it into certain geometric configurations. While such attempts have achieved moderate success, a number of limitations on performance, efficiency, and cost, still exist. Therefore, the possible applications for field emitters remain limited to small scale, low current output applications.

As such, materials capable of achieving high current outputs by absorbing relatively low amounts of energy from an energy source, and which are suitable for use in practical applications continue to be sought through ongoing research and development efforts.

### SUMMARY OF THE INVENTION

Accordingly, the present invention provides devices for converting energy and methods associated with such devices. In one aspect, for example, a surface for detection of infrared photons is provided. Such a surface may include at least one metal cone and a diamond-like carbon layer disposed on the at least one metal cone. The at least one diamond-like carbon-coated metal cone is thus configured to receive infrared photons and generate electrons therefrom. In another aspect, the at least one metal cone may be an array of electronically coupled metal cones.

Various forms of diamond-like carbon material may be used that will function to receive infrared photons and generate electrons therefrom. The selection of a particular diamond-like carbon material may vary depending on the intended use of the resulting device. In one aspect, for example, the diamond-like carbon layer may be amorphous carbon. In another aspect, the diamond-like carbon layer may include at least about 90% carbon atoms with at least about 20% of said carbon atoms being bonded with distorted tetrahedral coordination. In yet another aspect, the diamond-like carbon layer includes at least about 80% carbon atoms with at least about 20% of said carbon atoms being bonded with distorted tetrahedral coordination. Furthermore, the diamond-like carbon layer may be of a variety of thicknesses, depending on the design of the device. In one aspect, however, the diamond-like carbon layer may have a thickness of from about 10 nanometers to about 1 micron. In another aspect, the diamond-like carbon layer may have a thickness of less than about 500 nanometers. In yet another aspect, the diamond-like carbon layer may have a thickness of less than about 200 nanometers.

One factor that may be important in the uniformity of the detection of infrared photons across the surface of the metal cone array is the height and spacing distribution of the cones in the array. In one aspect, for example, the array of electrically coupled metal cones may have a tip to tip spacing distance of less than about 10 microns. In another aspect, the array of electrically coupled metal cones may have a tip to tip height variation of less than about 20% of the tip to tip spacing distance average.

The metal cones themselves may be constructed of a variety of conductive metals. In one aspect, non-limiting examples of metal materials may include Ni, Mo, Cu, Zn, Pd, Ag, W, Ta, Pt, Au, Ti, Fe, Co, Cr, and alloys and combinations thereof. In another more specific aspect, non-limiting examples of metal materials may include Ni, Mo, Cu, Ag, W, Cr, and alloys and combinations thereof.

The present invention also provides devices incorporating the diamond-like carbon-coated metal cone arrays as described herein. In one aspect, for example, a device for detection of infrared photons is provided, including a first electrode electrically coupled to the infrared photon detection surface as described herein, and a second electrode positioned adjacent to and facing the infrared photon detection surface, or more particularly, facing the metal cone array of the infrared photon detection surface. Additionally, in one aspect, infrared photon detection circuitry may be electrically coupled to the first electrode and to the second electrode to register electron flow due to infrared photon detection.

In another aspect of the present invention, a device may include a plurality of electrically isolated infrared photon detection surfaces, wherein each of the plurality of electrically isolated infrared photon detection surfaces is electrically coupled to one of a plurality of electrically isolated first electrodes. Such a collection of electrically isolated surfaces may allow the detection and comparison of discrete regions of an object or discrete regions of a spatial location.

The present invention also provides methods of making devices according to the various aspects of the present invention. In one aspect, a method of making a device for detection of infrared photons may include electrically coupling a first electrode to the array of diamond-like carbon coated electrically coupled metal cones as described herein, such that the metal cones project from the first electrode, and positioning a second electrode adjacent to and facing the metal cones, thus forming a gap between the first electrode and the second electrode. In one aspect, positioning the second electrode adjacent to and facing the metal cones may further include fixing the second electrode relative to the first electrode to maintain the gap. As such, the gap may be sealed around edges of the first and second electrodes, and a vacuum may be applied in the gap.

In another aspect, positioning a second electrode adjacent to and facing the metal cones may further include forming an intermediate member on the array of electrically coupled metal cones, where the intermediate member includes a dielectric material that is capable of supporting a voltage from about 0.1 V to about 6 V across the intermediate member. The second electrode may subsequently be coupled to the intermediate member opposite the first electrode.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 shows a cross-sectional view of one embodiment of an energy conversion device in accordance with the present invention.

FIG. 2 shows a cross-sectional view of another embodiment of an energy conversion device in accordance with the present invention.

FIG. 3 shows a cross-sectional view of yet another embodiment of an energy conversion device in accordance with the present invention.

FIG. 4 shows a cross-sectional view of a further embodiment of an energy conversion device in accordance with the present invention.

FIG. 5 shows an electron micrograph of an array of cones according to one aspect of the present invention.

FIG. 6 shows a cross-sectional view of one embodiment of an energy conversion device in accordance with the present invention.

FIG. 7 shows a cross-sectional view of another embodiment of an energy conversion device in accordance with the present invention.

FIG. 8 shows a cross-sectional view of yet another embodiment of an energy conversion device in accordance with the present invention.

FIG. 9 shows a cross-sectional view of a further embodiment of an energy conversion device in accordance with the present invention.

FIG. 10 shows a cross-sectional view of yet a further embodiment of an energy conversion device in accordance with the present invention.

FIG. 11 shows a cross-sectional view of one embodiment of an energy conversion device in accordance with the present invention.

FIG. 12 shows a cross-sectional view of another embodiment of an energy conversion device in accordance with the present invention.

The drawings will be described further in connection with the following detailed description. Further, these drawings are not necessarily to scale and are by way of illustration only such that dimensions and geometries can vary from those illustrated.

### DETAILED DESCRIPTION

Before the present invention is disclosed and described, it is to be understood that this invention is not limited to the particular structures, process steps, or materials disclosed herein, but is extended to equivalents thereof as would be recognized by those ordinarily skilled in the relevant arts. It should also be understood that terminology employed herein is used for the purpose of describing particular embodiments only and is not intended to be limiting.

It must be noted that, as used in this specification and the appended claims, the singular forms “a,” “an,” and “the” include plural referents unless the context clearly dictates otherwise. Thus, for example, reference to “a layer” includes one or more of such layers, reference to “a carbon source” includes reference to one or more of such carbon sources, and reference to “a cathodic arc technique” includes reference to one or more of such techniques.

Definitions

In describing and claiming the present invention, the following terminology will be used in accordance with the definitions set forth below.

As used herein, “vacuum” refers to a pressure condition of less than 10⁻² torr.

As used herein, “diamond” refers to a crystalline structure of carbon atoms bonded to other carbon atoms in a lattice of tetrahedral coordination known as sp³ bonding. Specifically, each carbon atom is surrounded by and bonded to four other carbon atoms, each located on the tip of a regular tetrahedron. Further, the bond length between any two carbon atoms is 1.54 angstroms at ambient temperature conditions, and the angle between any two bonds is 109 degrees, 28 minutes, and 16 seconds although experimental results may vary slightly. The structure and nature of diamond, including its physical and electrical properties are well known in the art.

As used herein, “distorted tetrahedral coordination” refers to a tetrahedral bonding configuration of carbon atoms that is irregular, or has deviated from the normal tetrahedron configuration of diamond as described above. Such distortion generally results in lengthening of some bonds and shortening of others, as well as the variation of the bond angles between the bonds. Additionally, the distortion of the tetrahedron alters the characteristics and properties of the carbon to effectively lie between the characteristics of carbon bonded in sp³ configuration (i.e. diamond) and carbon bonded in sp² configuration (i.e. graphite). One example of material having carbon atoms bonded in distorted tetrahedral bonding is amorphous diamond.

As used herein, “diamond-like carbon” refers to a carbonaceous material having carbon atoms as the majority element, with a substantial amount of such carbon atoms bonded in distorted tetrahedral coordination. Diamond-like carbon (DLC) can typically be formed by PVD processes, although CVD or other processes could be used such as vapor deposition processes. Notably, a variety of other elements can be included in the DLC material as either impurities, or as dopants, including without limitation, hydrogen, sulfur, phosphorous, boron, nitrogen, silicon, tungsten, etc.

As used herein, “amorphous diamond” refers to a type of diamond-like carbon having carbon atoms as the majority element, with a substantial amount of such carbon atoms bonded in distorted tetrahedral coordination. In one aspect, the amount of carbon in the amorphous diamond can be at least about 90%, with at least about 20% of such carbon being bonded in distorted tetrahedral coordination. In another aspect, the amount of carbon in the amorphous diamond can be at least about 80%, with at least about 20% of such carbon being bonded in distorted tetrahedral coordination. Amorphous diamond also has a higher atomic density than that of diamond (176 atoms/cm³). Further, amorphous diamond and diamond materials contract upon melting.

As used herein, “vapor deposited” refers to materials which are formed using vapor deposition techniques. “Vapor deposition” refers to a process of depositing materials on a substrate through the vapor phase. Vapor deposition processes can include any process such as, but not limited to, chemical vapor deposition (CVD) and physical vapor deposition (PVD). A wide variety of variations of each vapor deposition method can be performed by those skilled in the art. Examples of vapor deposition methods include hot filament CVD, rf-CVD, laser CVD (LCVD), laser ablation, conformal diamond coating processes, metal-organic CVD (MOCVD), sputtering, thermal evaporation PVD, ionized metal PVD (IMPVD), electron beam PVD (EBPVD), reactive PVD, and the like.

As used herein, “electron affinity” refers to the tendency of an atom to attract or bind a free electron into one of its orbitals. Further, “negative electron affinity” (NEA) refers to the tendency of an atom to either repulse free electrons, or to allow the release of electrons from its orbitals using a small energy input. NEA is generally the energy difference between a vacuum and the lowest energy state within the conduction band. Those of ordinary skill in the art will recognize that negative electron affinity may be imparted by the compositional nature of the material, or the crystal irregularities, e.g. defects, inclusions, grain boundaries, twin planes, or a combination thereof.

As used herein, “dielectric” refers to any material which is electrically resistive. Dielectric materials can include any number of types of materials such as, but not limited to, glass, polymers, ceramics, graphites, alkaline and alkali earth metal salts, and combinations or composites thereof.

As used herein, “work function” refers to the amount of energy, typically expressed in eV, required to cause electrons in the highest energy state of a material to emit from the material into a vacuum space. Thus, a material such as copper having a work function of about 4.5 eV would require 4.5 eV of energy in order for electrons to be released from the surface into a theoretical perfect vacuum at 0 eV.

As used herein, “electrically coupled” refers to a relationship between structures that allows electrical current to flow at least partially between them. This definition is intended to include aspects where the structures are in physical contact and those aspects where the structures are not in physical contact. Typically, two materials which are electrically coupled can have an electrical potential or actual current between the two materials. For example, two plates physically connected together by a resistor are in physical contact, and thus allow electrical current to flow between them. Conversely, two plates separated by a dielectric material are not in physical contact, but, when connected to an alternating current source, allow electrical current to flow between them by capacitive means. Moreover, depending on the insulative nature of the dielectric material, electrons may be allowed to bore through, or jump across the dielectric material when enough energy is applied.

As used herein, “energy converter” is used to describe a device that converts energy from one form to another. Examples of energy converters may include, without limitation, field emission devices, thermoelectric converters, etc.

As used herein, “infrared” is used to describe electromagnetic radiation of a wavelength that is longer than visible light, but that is shorter than radio waves.

As used herein, “thermoelectric conversion” relates to the conversion of thermal energy to electrical energy or of electrical energy to thermal energy, or flow of thermal energy. Further, in context of the present invention, diamond-like carbon typically operates under thermionic emission. As discussed elsewhere herein, thermionic emission is a property wherein increased electron emission is achieved from a material with increases in temperatures. Diamond-like materials such as amorphous diamond exhibit thermionic emission at temperatures far below that of most materials. For example, many materials tend to exhibit substantial thermionic emission or temperature related effects in emission properties at temperatures over about 1100° C. In contrast, amorphous diamond exhibits increases in emission at temperature changes near room temperature up to 1000° C. or more. Thus, thermionic materials such as amorphous diamond can be useful at temperatures from below room temperature to about 300° C.

As used herein, “asperity” refers to the roughness of a surface as assessed by various characteristics of the surface anatomy. Various measurements may be used as an indicator of surface asperity, such as the height of peaks or projections thereon, and the depth of valleys or concavities depressing therein. Further, measures of asperity include the number of peaks or valleys within a given area of the surface (i.e. peak or valley density), and the distance between such peaks or valleys.

As used herein, “metallic” refers to a metal, or an alloy of two or more metals. A wide variety of metallic materials are known to those skilled in the art, such as aluminum, copper, chromium, iron, steel, stainless steel, titanium, tungsten, zinc, zirconium, molybdenum, etc., including alloys and compounds thereof.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc., as well as 1, 2, 3, 4, and 5, individually.

This same principle applies to ranges reciting only one numerical value as a minimum or a maximum. Furthermore, such an interpretation should apply regardless of the breadth of the range or the characteristics being described.

The Invention

One method of constructing an energy conversion surface may involve creating a plurality of metal cones on a substrate. It has proven difficult, however, to construct such a surface having a uniform distribution of energy conversion. For example, prior attempts to manufacture field emission surfaces having a plurality of metal cones have resulting in emitters having non-uniform illumination across the surface, thus making them unsuitable for may uses such as LCD backlighting and such. Much of this difficulty has come from an inability to produce a precisely spaced array of metal cones that are small enough to provide a uniform emission.

The present invention thus provides devices for the conversion of energy and methods associated with such devices. In one aspect, for example, an array of small metal cones can be fabricated and used as a surface for the detection of infrared photons. Such a surface may include at least one metal cone and a diamond-like carbon layer disposed on the at least one metal cone. The at least one diamond-like carbon-coated metal cone is thus configured to receive infrared photons and generate electrons therefrom. In another aspect, the at least one metal cone may be an array of electronically coupled metal cones.

It is intended that the cone or cone arrays of the infrared detection surface be configured to act as infrared “antennas” to collect infrared photons that can be converted to electricity and detected by appropriate detection circuitry. A diamond-like carbon layer may be applied to the cone or cones of the surface to facilitate the collection of photons and the subsequent conversion to electrons. Amorphous diamond and diamond-like carbon layers have a lower work function, and thus may more effectively absorb infrared photons. Additional details regarding amorphous diamond and diamond-like carbon layers used in energy conversion can be found in U.S. Pat. No. 6,949,873 filed on Jun. 11, 2003, and U.S. patent application Ser. No. 11/112,724, filed Apr. 21, 2005, both of which are incorporated herein by reference in their entirety.

Due to its high band gap properties, diamond is generally unsuitable for use as a photon absorber unless modified to reduce or alter the band gap. Thus far, the techniques for altering diamond band gap, such as doping the diamond with various dopants, and configuring the diamond with certain geometric aspects have yielded devices, particularly electron emitters, which are of questionable use.

It has now been found that various diamond-like carbon materials can easily absorb infrared photons. Such materials retain the NEA properties of diamond, but do not suffer from the band gap issues of pure diamond. Thus, infrared photons are allowed to move readily into, and thus be collected by the diamond-like carbon material. Electrons thus excited by the infrared photons subsequently move into the metal cone or cones to be utilized as an electrical potential or current. Furthermore, the diamond-like carbon material of the present invention has been found to have a high energy absorption range, thus allowing for a wider range of energies to be converted into electrons, and thus increasing the conversion efficiency.

A variety of specific diamond-like carbon materials that provide the desired qualities are encompassed by the present invention. In one specific aspect, the diamond-like carbon material can be amorphous diamond material. One property of the amorphous diamond material that facilitates infrared photon absorption is the distorted tetrahedral coordination with which many of the carbon atoms are bonded. Tetrahedral coordination allows carbon atoms to retain the sp³ bonding characteristic that may facilitate the surface condition required for NEA, and also provides a plurality of effective band gaps, due to the differing bond lengths of the carbon atom bonds in the distorted tetrahedral configuration. In this manner, the band gap issues of pure diamond are overcome, and the amorphous diamond material becomes effective for absorbing infrared photons. In one aspect of the present invention, the amorphous diamond material can contain at least about 90% carbon atoms with at least about 20% of such carbon atoms being bonded with distorted tetrahedral coordination. In another aspect, the amorphous diamond can have at least about 95% carbon atoms with a least about 30% of such carbon atoms being bonded with distorted tetrahedral coordination. In another aspect, the amorphous diamond can have at least about 80% carbon atoms with at least about 20%, and more preferably at least about 30%, of such carbon atoms being bonded with distorted tetrahedral coordination. In yet another aspect, the amorphous diamond can have at least 50% of the carbon atoms bonded in distorted tetrahedral coordination.

Another aspect of the present amorphous diamond material that facilitates infrared photon absorption may include the presence of certain geometric configurations in the material. For example, asperities formed in the surface of the amorphous diamond material function to further focus and thus increase the energy conversion or absorption properties of the material beyond what is observed by the cones. In one aspect, the asperities of the absorption surface can have a height of from about 10 nanometers to about 1,000 nanometers. In another aspect, the asperity of the absorption surface can have a height of from about 10 nanometers to about 500 nanometers. In another aspect, the asperity height can be about 100 nanometers. In yet another aspect, the asperity height can be about 50 nanometers. Further, the asperities can have a peak density of at least about 1 million peaks per square centimeter of absorption surface. In yet another aspect, the peak density can be at least about 100 million peaks per square centimeter of the absorption surface. In a further aspect, the peak density can be at least about 1 billion peaks per square centimeter of the absorption surface. Any number of height and density combinations can be used in order to achieve a specific absorption surface asperity, as required in order to generate a desired electron output. However, in one aspect, the asperity can include a height of about 100 nanometers and a peak density of at least about, or greater than about 1 million peaks per square centimeter of emission surface. In yet another aspect, the asperity can include a height of about 100 nanometers and a peak density of at least about, or greater than 1 billion peaks per square centimeter of emission surface.

Geometric configurations of the amorphous diamond layer on a much larger scale than the asperities described may also greatly enhance the characteristics of the absorption surface by further focusing the infrared photon absorption. While a number of prior devices have attempted to thusly focus electrons, for example by imparting a plurality of pyramids or cones to an emission surface, none have as of yet, been able to achieve the high current output required to be viable for many applications using a feasible energy input in a cost effective manner. More often than not, this inadequacy results from the fact that the pyramids, cones, etc. are too large and insufficiently dense to focus the electrons as needed to enhance flow. Such sizes are often greater than several microns in height, thus allowing only a projection density of less than 1 million per square centimeter. While carbon nanotubes have achieved higher outputs than other known emitters, carbon nanotubes have shown to be fragile, short lived, and inconsistent in the levels and flow of electrons achieved.

As will be described further herein, it has been discovered that a very dense array of cones may be constructed that is capable of overcoming many of the shortcomings of prior energy conversion surfaces. The density and size of the cones in the array are such that they are particularly suitable for use as highly efficient infrared photon absorption surfaces. As will also be further described, a temporary substrate having precisely cut cone-shaped depressions can be used as a mold to form the cone array. In some aspects, the temporary substrate is consumed in the manufacture of the array, while in other aspects the temporary substrate may be reused, thus increasing the cost-effectiveness of the manufacturing process.

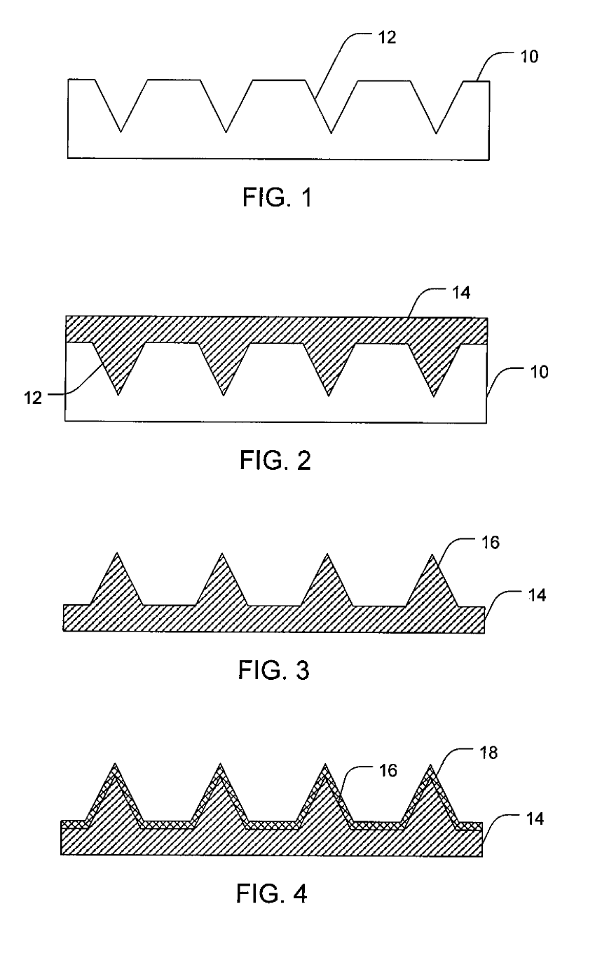

Turning to FIG. 1, in one aspect a method for making such an array of cones for an energy conversion device may include forming a plurality of cone-shaped depressions 12 in a temporary substrate 10. The temporary substrate 10 may be any useful material known to one of ordinary skill in the art that is capable of supporting the cone-shaped depressions 12 and able to withstand subsequent cone array processing. Non-limiting examples may include glass, polymeric materials such as plastics, epoxies, acrylics, etc., metals, ceramics, etc. Additionally, any process capable of forming the cone-shaped depressions 12 described herein in the temporary substrate 10 would be considered to be within the scope of the present invention. In one aspect, for example, the cone-shaped depressions may be drilled with an excimer laser. In another aspect, the cone-shaped depressions may be created by masking the substrate and chemically etching.

The temporary substrate 10 may be any useful material known to one of ordinary skill in the art that is capable of supporting the cone-shaped depressions 12 and able to withstand subsequent cone array processing. Non-limiting examples may include glass, polymeric materials such as plastics, epoxies, acrylics, etc., metals, ceramics, etc.

Following the formation of the plurality of cone-shaped depressions in the temporary substrate, the array of cones may be formed in a variety of ways. In one aspect, for example, a layer of metal 14 may be deposited on the temporary substrate 10 such that each of the plurality of cone-shaped depressions 12 is at least partially filed with the layer of metal 14, as is shown in FIG. 2. Following deposition of the layer of metal 14, the temporary substrate may be removed as shown in FIG. 3 to expose the plurality of electrically coupled metal cones 16. The resulting metal cones thus have a shape, size, and density that are very similar to the shape, size, and density of the plurality of cone-shaped depressions. In another aspect of the present invention, a support substrate may be coupled to the array of metal cones prior to removal of the temporary substrate. In some cases the support substrate may be an electrode.

The material used for the metal layer may be any conductive metal known to one of ordinary skill in the art. Examples of useful metals may include, without limitation, Ni, Mo, Cu, Zn, Pd, Ag, W, Ta, Pt, Au, Ti, Fe, Cr, Co, and alloys and combinations thereof. In one aspect, the metal may include Ni, Mo, Cu, Ag, W, Cr, and alloys and combinations thereof. In one specific aspect, the metal may be Ni or an alloy containing Ni. Additionally, the layer of metal may be deposited by any means known, including, but not limited to, sputtering, vapor deposition, molten application, electroplating, etc. It should also be noted that metals such as Li, Na, K, Mg, Ce, Sm can be used, provided they are covered with amorphous diamond to prevent oxidation. These elements have lower work functions, and are thus closer to the vacuum state.

As has been described, the diamond-like carbon materials disclosed herein can greatly affect the energy conversion properties of the array of metal cones. Accordingly, a diamond-like carbon layer 18 may be deposited onto the plurality of electrically coupled metal cones 16, as is shown in FIG. 4. The diamond-like carbon layer may thus serve to facilitate the absorption of infrared photons along the cone structures. In one form of energy conversion, for example, infrared photons impinging on the diamond-like carbon layer 18 are absorbed to excite electrons to flow through the metal layer 14, in part due to the geometrical configuration of the metal cones and the efficient absorption surface provided by the diamond-like carbon.

The diamond-like carbon or amorphous diamond materials used in the present invention can be produced using a variety of processes known to those skilled in the art. However, in one aspect, the material can be made using a cathodic arc method. Various cathodic arc processes are well known to those of ordinary skill in the art, such as those disclosed in U.S. Pat. Nos. 4,448,799; 4,511,593; 4,556,471; 4,620,913; 4,622,452; 5,294,322; 5,458,754; and 6,139,964, each of which is incorporated herein by reference. Generally speaking, cathodic arc techniques involve the physical vapor deposition (PVD) of carbon atoms onto a target, or substrate. The arc is generated by passing a large current through a graphite electrode that serves as a cathode, and vaporizing carbon atoms with the current. The vaporized atoms also become ionized to carry a positive charge. A negative bias of varying intensity is then used to drive the carbon atoms toward an electrically conductive target. If the carbon atoms contain a sufficient amount of energy (i.e. about 100 eV) they will impinge on the target and adhere to its surface to form a carbonaceous material, such as amorphous diamond. Amorphous diamond can be coated on almost any metallic substrate, typically with no, or substantially reduced, contact resistance.

In general, the kinetic energy of the impinging carbon atoms can be adjusted by the varying the negative bias at the substrate and the deposition rate can be controlled by the arc current. Control of these parameters as well as others can also adjust the degree of distortion of the carbon atom tetrahedral coordination and the geometry, or configuration of the amorphous diamond material (i.e. for example, a high negative bias can accelerate carbon atoms and increase sp³ bonding). By measuring the Raman spectra of the material the sp³/sp² ratio can be determined. However, it should be kept in mind that the distorted tetrahedral portions of the amorphous diamond layer are neither sp³ nor sp² but a range of bonds which are of intermediate character. Further, increasing the arc current can increase the rate of target bombardment with high flux carbon ions. As a result, temperature can rise so that the deposited carbon will convert to more stable graphite. Thus, final configuration and composition (i.e. band gaps, NEA, and emission surface asperity) of the amorphous diamond material can be controlled by manipulating the cathodic arc conditions under which the material is formed. Additionally, other processes can be used to form DLC such as various vapor deposition processes, e.g. PVD or the like.

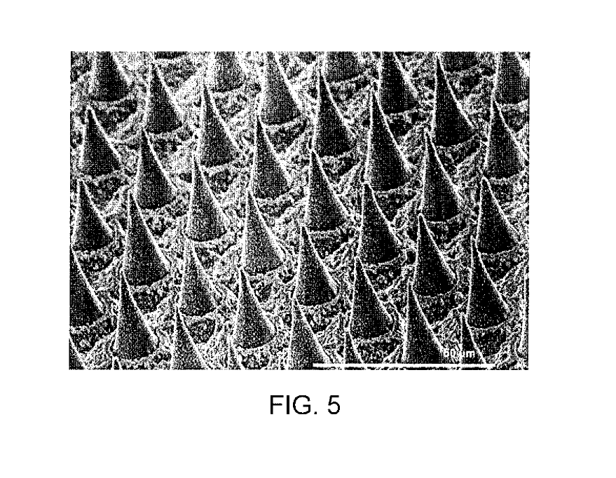

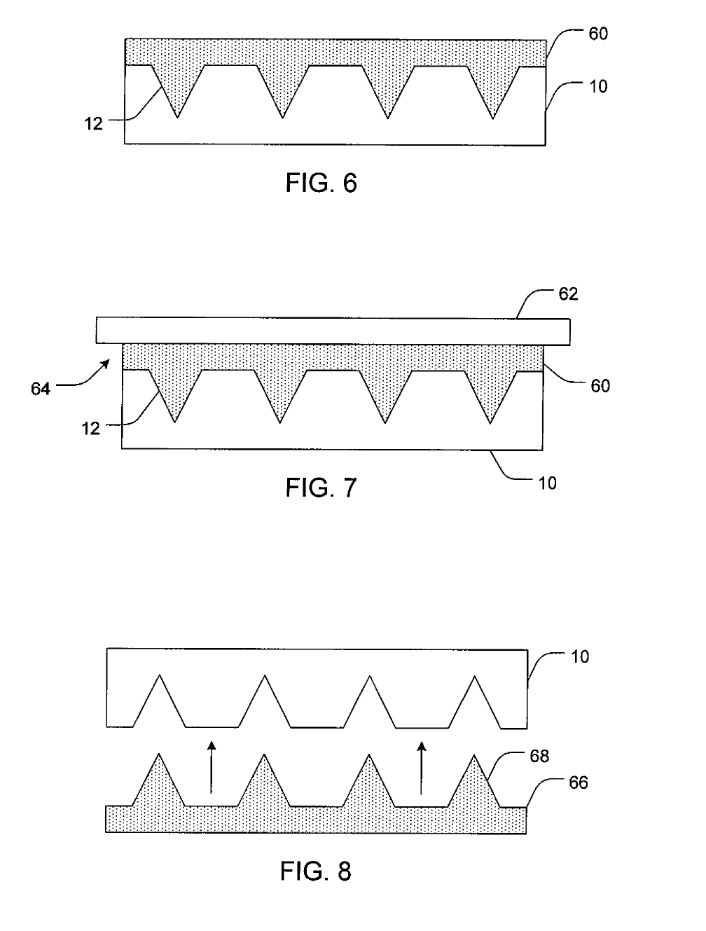

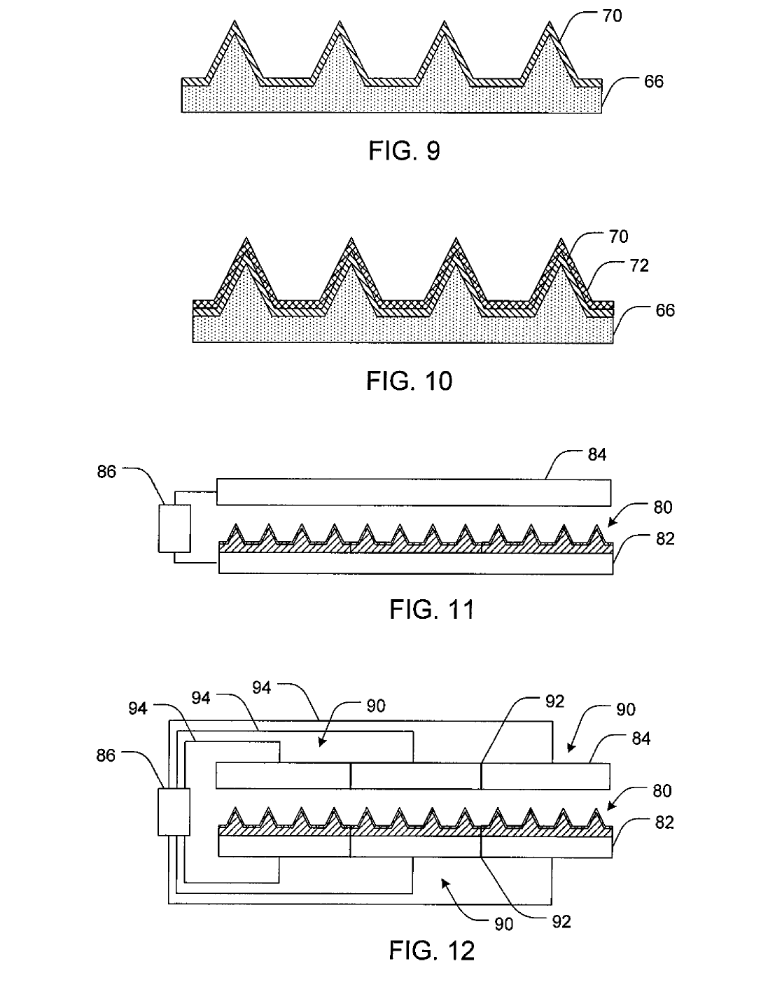

An electron micrograph of a metal cone array made according to one aspect of the present invention is shown in FIG. 5. This cone array is shown prior to deposition of the diamond-like carbon layer. It should be noted that the cones are all of a very similar shape and size, and that the spacing between the cones is very precise. The parameters of cone shape, size, and spacing may vary somewhat depending on the intended use of the cone array. In one aspect, however, the plurality of electrically coupled metal cones may have a tip-to-tip spacing distance of less than 10 microns. In another aspect, the plurality of electrically coupled metal cones may have a tip-to-tip spacing distance of less than 10 microns and a tip-to-tip height variation of less than about 20% of the tip-to-tip spacing distance average.

In another aspect of the present invention, the cone array may be formed such that the temporary substrate may be subsequently reused. Following the formation of cone-shaped depressions 12 in a temporary substrate 10 as has been described, an at least partially uncured polymeric material 60 may be applied to the temporary substrate 10 to substantially fill the cone-shaped depressions 12 and to cover the temporary substrate 10 between the plurality of cone-shaped depressions. Numerous methods of applying the uncured polymeric material to the temporary substrate are contemplated, all of which would be considered to be within the scope of the present invention. For example, and without limitation, the uncured polymeric material may be applied by spraying, pouring, injection molding, etc. In one aspect, the material may be applied by injection molding. As is shown in FIG. 7, a stop surface 62 may be positioned adjacent to and facing the plurality of cone-shaped depressions 12 at a distance from the temporary substrate 10 to form a gap 64 between the stop surface 62 and the temporary substrate 10. Following positioning of the stop surface 62, the at least partially uncured polymeric material 60 may be injected into the gap 64 to at least substantially fill the cone depressions 12 and the gap 64. By using such an injection molding process, the uncured polymer is forced to the very tips of the cone depressions, thus improving the sharpness and consistency of the cones in the cone array.

Following the application of the uncured polymeric material to the temporary substrate, the uncured polymeric material may be cured to form a cured polymeric material. Curing the polymeric material may be accomplished by any means known, and thus may be variable depending on the type of polymeric material being utilized. Following curing of the cured polymeric material 66, the temporary substrate 10 is removed, as is shown in FIG. 8. Following removal from the temporary substrate 10, the cured polymeric material 66 has a plurality of polymeric cones 68 coupled together in a pattern corresponding to the pattern of the plurality of cone-shaped depressions. Various non-sticking agents may be applied to the temporary substrate to avoid sticking of the polymeric material. One non-limiting example of such a non-sticking agent would be spraying the temporary substrate with boron nitride.

Numerous polymeric materials are known, including various thermoplastic and thermosetting polymers. It should be noted that any polymeric material capable of forming polymeric cones according to the various aspects of the present invention should be considered to be within the scope of the present invention. Non-limiting examples may include amino resins, acrylate resins, alkyd resins, polyester resins, polyamide resins, polyimide resins, polyurethane resins, phenolic resins, phenolic/latex resins, epoxy resins, isocyanate resins, isocyanurate resins, polysiloxane resins, reactive vinyl resins, polyethylene resins, polypropylene resins, polystyrene resins, phenoxy resins, perylene resins, polysulfone resins, acrylonitrile-butadiene-styrene resins, acrylic resins, polycarbonate resins, polyimide resins, and mixtures thereof. The cured polymeric material may also include additional components that modify the characteristics of the material. In one aspect, a reinforcing material may be disposed within at least a portion of the cured polymeric material. The reinforcing material may be, without limitation, ceramics, metals, or combinations thereof. Examples of ceramic materials include alumina, aluminum carbide, silica, silicon carbide, zirconia, zirconium carbide, and mixtures thereof. Additional additives that may enhance the metal deposition steps described herein may also be included in the cured polymeric material. In some aspects, a support substrate may be coupled to the cured polymeric material prior to removal of the temporary substrate in order to increase the strength of the cone array and to facilitate handling. In some aspects, the support substrate may be an electrode.

Following separation of the cured polymeric material from the temporary substrate, a layer of metal 70 may be deposited onto the cured polymeric material 66 to form a plurality of electrically coupled metal cones. The metal material utilized as the layer of metal may be any metal known, as has been discussed in other aspects of the present invention. The layer of metal may be deposited utilizing a variety of known techniques, all of which should be considered to be within the scope of the present invention. Such techniques may include, without limitation, electro-deposition, vapor deposition, sputtering, etc. Following deposition of the layer of metal, a diamond-like carbon layer 72 may be deposited onto the layer of metal 70 as is shown in FIG. 10. The properties of the diamond-like carbon material and the deposition thereof may be accomplished as has been described herein.

The resulting metal cone array may be further processed in a variety of ways. In one aspect, for example, the metal cone array including the cured polymeric material can be electronically coupled to an electrode for further inclusion into a specific energy conversion device, such as an infrared photon detection device. In another aspect, the cured polymeric material may serve as a support for the metal cone array, and the metal cone array itself may serve as an electrode once coupled to a proper power source. In yet another aspect, the cured polymeric material may be replaced by additional metal. For example, the cured polymeric material may be removed by a method used to dissolve the particular polymer. In some cases, heat that is below the melting point of the layer of metal may be used to melt and remove the cured polymeric material. Following removal, additional metal may be deposited onto surfaces from which the cured polymeric material was removed. In one aspect, the additional metal may at least substantially fill the array of metal cones, thus forming a solid or semi-solid structure similar to that shown in FIG. 3. In another aspect, the array of metal cones may be merely thickened in order to increase the strength and durability of the cone array, without completely filling in the cones. In yet another aspect, the cone array may have been manufactured to such a thickness as to not require the deposition of additional metal. However, any cone array structure may be utilized as an electrode itself, or it may be further coupled to an additional electrically conductive material.

The diamond-like carbon cone arrays of the present invention can be further coupled to, or associated with a number of different components in order to create various devices. Referring now to FIG. 11, in one aspect a diamond-like carbon infrared photon detection device is shown. An array of diamond-like carbon-coated metal cones 80 may be electrically coupled to a first electrode 82. The first electrode may be a layer of conductive metal or other material, or the first electrode may be the metal portion of the array of diamond-like carbon-coated metal cones 80. The array may be coupled to the first electrode by any means known. For example, in one aspect the array may be coupled to the electrode by a conductive means, such as by brazing or coupled with a conductive adhesive. In another aspect, the array may be coupled to the electrode by a non-conductive means, such as through the use of a polymeric adhesive. In such cases, a conductive pathway must be formed between the array and the first electrode.

A second electrode 84 may be positioned adjacent to and facing the array of diamond-like carbon-coated metal cones 80. Infrared photon detection circuitry 86 may be electrically coupled to both the first electrode 82 and the second electrode 84 in order to detect electrical current due to the absorption of infrared photons. In another aspect, the device may further include a power source (not shown).

As has been described, many of the above-recited components can take a variety of configurations and be made from a variety of materials. Each of the layers discussed can be formed using any number of known techniques such as, but not limited to, vapor deposition, thin film deposition, preformed solids, powdered layers, screen printing, or the like. In one aspect, each layer is formed using deposition techniques such as PVD, CVD, or any other known thin-film deposition process. In one aspect, the PVD process is sputtering or cathodic arc. Further, suitable electrically conductive materials and configurations will be readily recognized by those skilled in the art for the electrodes. Such materials and configurations can be determined in part by the function of the device into which the assembly is incorporated. Additionally, the layers can be brazed, glued, or otherwise affixed to one another using methods which do not interfere with the thermal and electrical properties as discussed.

Although, a variety of geometries and layer thicknesses can be used, very thin diamond-like carbon layers may be beneficial to facilitate the conversion of electrons to current rather than heat. Electrons in thick diamond-like carbon layers have a tendency to convert to heat rather than current. In one aspect, for example, the diamond-like carbon layer may have a thickness of from about 10 nanometers to about 1 micron. In another aspect, the diamond-like carbon layer may have a thickness of less than about 500 nanometers. In yet another aspect, the diamond-like carbon layer may have a thickness of less than about 200 nanometers. Other layers associated with the device typically have thicknesses of from about 1 micron to about 1 millimeter.

Returning to FIG. 11, various configurations are contemplated. For example, in one aspect a vacuum may be formed between the first electrode 82 and the second electrode 84. Additionally, in other aspect, various devices may be formed having a dielectric layer between the electrodes according to aspects of the present invention. In the case of FIG. 11, the dielectric layer may be located between the first electrode 82 and the second electrode 84. The dielectric material can be any dielectric material known to one of ordinary skill in the art, including polymers, glasses, ceramics, inorganic compounds, organic compounds, or mixtures thereof. Examples include, without limitation, BaTiO₃, PZT, Ta₂O₃, PET, PbZrO₃, PbTiO₃, NaCl, LiF, MgO, TiO₂, Al₂O₃, BaO, KCl, Mg₂SO₄, fused silica glass, soda lime silica glass, high lead glass, and mixtures or composites thereof. In one aspect, the dielectric material is BaTiO₃. In another aspect, the dielectric material is PZT. In another aspect, the dielectric material is PbZrO₃. In yet another aspect, the dielectric material is PbTiO₃. Additionally, the dielectric material can be a graphitic material. A number of graphitic materials can have a sufficiently high electrical resistivity to support a voltage of 0.1 V. Further, materials having a relatively low thermal conductivity such as hexagonal boron nitride (about 40 W/mK), alumina, zirconia, other ceramics, or dielectrics listed above can be mixed with relatively higher thermal conductivity graphite (above about 200 W/mK). For example, in one currently preferred embodiment the intermediate member can comprise graphite and hexagonal boron nitride. These materials can be provided as a layered combination or as a compressed powder mixture.

The dielectric material can be configured in any way that maintains separation between the diamond-like carbon layer and the second electrode. In another alternative aspect, the dielectric material can be a single layer or a number of layers. In this case the dielectric material can be tailored to improve conversion efficiency and the more closely match the bandgap of adjacent materials. Advantageously, this configuration of dielectric layers may decrease the incidence of preferred pathways of electron flow, due to a more uniform distribution of charge across the intermediate member. Further, in such multi-layered configurations, the intermediate member can include one or more additional layers of diamond-like carbon.

In another aspect of the present invention, an infrared photon detection device may include a plurality of absorption surfaces. As is shown in FIG. 12, such a device may include a plurality of infrared absorption units 90, with each unit having an array of diamond-like carbon-coated metal cones 80, a first electrode 82, and a second electrode 84 as has been described in FIG. 11. Each infrared absorption unit 90 may be electrically isolated from other units with a dielectric separator 92, such that the entire array of infrared absorption units corresponds to a series of discrete regions in space opposite to the absorption surface of the device. The dielectric separator 92 may be any dielectric material known that is capable of maintaining the electrical isolation of the units 90. The device may include infrared photon detection circuitry 86 as has been described. In some aspects, each infrared absorption unit may be electrically coupled to the infrared photon detection circuitry via a separate conductive line 94 to maintain the electrical isolation of the unit 90. Thus by comparing the electrical activity in each infrared absorption unit, a thermal map of the space opposite to the device may be created.

The present invention also encompasses methods for making the diamond-like carbon infrared photon conversion devices disclosed herein, as well as methods for the use thereof. Such thermal devices may be used for a variety of thermal imaging tasks, including night vision, temperature readings, search and rescue applications, thermal microscopy, etc. In the case of thermal microscopy, one or more diamond-like carbon cones may be used to scan an object in order to measure single or very few infrared photons emanating from a microscopic sample. The emission and detection of such photons may thus allow a microscopic image to be generated, similar to atomic force microscopy techniques.

The amorphous or diamond-like carbon material of the present invention is capable of utilizing a variety of different energy input types for conversion. Examples of suitable energy types can include without limitation, heat or thermal energy and light or photonic energy. Thus, suitable energy sources are not limited to visible light or any particular frequency range and can include the entire visible, infrared, and ultraviolet ranges of frequencies. Those of ordinary skill in the art will recognize other energy types that may be capable of sufficiently vibrating the electrons contained in the amorphous diamond material to affect their release and movement through the metal cones according to aspects of the present invention. Further, various combinations of energy types can be used in order to achieve a specifically desired result, or to accommodate the functioning of a particular device into which the amorphous diamond material is incorporated.

In one aspect of the present invention, energy may be used to facilitate electron flow, and such energy may be in the form of electric field energy (i.e. a positive bias). Thus, in some embodiments of the present invention a positive bias can be applied in conjunction with the infrared photons. Such a positive bias can be applied to the amorphous diamond material and/or intermediate member described herein, or with a variety of other mechanisms known to those of ordinary skill in the art. Specifically, the negative terminal of a battery or other current source can be connected to the electrode and/or amorphous diamond and the positive terminal connected to the intermediate material or gate member placed between the amorphous diamond electron emission surface and the anode.

The following are examples illustrate various methods of making infrared photon conversion devices in accordance with the present invention. However, it is to be understood that the following are only exemplary or illustrative of the application of the principles of the present invention. Numerous modifications and alternative compositions, methods, and systems can be devised by those skilled in the art without departing from the spirit and scope of the present invention. The appended claims are intended to cover such modifications and arrangements. Thus, while the present invention has been described above with particularity, the following Examples provide further detail in connection with several specific embodiments of the invention.

### EXAMPLE 1

Grooves are cut in a steel rod with a sharp diamond tip made of a single crystal to form alternating V-shaped ridges and valleys. The grooved steel rod is then rolled against a PET film (polyethylene terephthalate) to form a series of parallel V-shaped ridges in the film. The steel roll is again rolled against the PET film to form V-shaped ridges in a direction that is perpendicular to the previous roll-direction, thus forming tetragonal pyramids of a few microns in size distributed in a grid pattern. The PET film is sputter coated with a nanometer thick film of Cr, and then overcoated with an epoxy for support. The underlying PET film is then dissolved away to expose the Cr layer. The Cr layer is immersed in an electrolyte and plated with Ni until the entire surface is covered with Ni. The top epoxy layer is then dissolved away to expose Cr. The Cr layer is then coated with amorphous diamond by cathodic arc to a thickness of about 100 nm. An ITO (indium tin oxide) coated glass is positioned to face the amorphous diamond coating with glass wires as spacers to keep the amorphous diamond tips a few microns away from the ITO glass. The space there between is then sealed around the edges with silicone after which a vacuum is introduced.

### EXAMPLE 2

An excimer laser is used to cut a series of inverse pyramids in a glass surface. A second glass surface is positioned opposite to the inverse pyramids, and an epoxy is injection molded into the space there between to fill the gap and the inverse pyramids. The glass is then etched away to expose the epoxy pyramids. The surface including the pyramids is sputtered with Cr and then overcoated with an epoxy for support. The epoxy is removed from the backside to expose the Cr layer. Ni is then electroplated onto the Cr layer, and the device is further processed as described in Example 1.

### EXAMPLE 3

A silicon wafer is masked and etched with a KOH solution to form microscopic inverse pyramids (tetragonal shaped with a 111 wafer face, or triangular shaped with a 100 wafer face) that are tightly spaced (about one million per square centimeter). The etched surface is sputter coated with W and electroplated with Ni to form a base support. The Si wafer is then removed by dissolution in KOH solution. The microtips of W are then coated with amorphous diamond. An ITO glass electrode is positioned to face the amorphous diamond-coated tips with a gap of about 5 microns. In this case, a vacuum is not applied to the gap. The device may be used as an infrared radiation detector. The amount of radiation is measured as the potential difference between the two electrodes. If the temperature is higher outside than inside, the electrons will move from micro tips to the Ni base, and vice versa.

### EXAMPLE 4

Emission surfaces are constructed as described in Example 1. Multiple compartmentalized sections of microtips are incorporated into a large emission surface. Each of the compartmentalized sections contains one or more mircotip, and is separated from adjacent sections by a dielectric material. Each section or “pixel” of microtips can be addressed by two sets of electrodes that are perpendicular to each other so individual X-Y coordinates can be activated by applying a bias of voltage. An ITO electrode is fixed opposite to and facing the surface of microtips. Infrared photonic input can thus trigger a microvolt change in of individual pixels. This device is used for measuring temperature distribution of an object.

Of course, it is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

What is claimed is:

1. A surface for detection of infrared photons, comprising:
at least one metal cone;
a diamond-like carbon layer disposed on the at least one metal cone, said at least one diamond-like carbon-coated metal cone being configured to receive infrared photons and generate electrons therefrom.

2. The surface of claim 1, wherein the at least one metal cone is an array of electronically coupled metal cones.

3. The surface of claim 1, wherein the diamond-like carbon layer is amorphous carbon.

4. The surface of claim 1, wherein the diamond-like carbon layer includes at least about 90% carbon atoms with at least about 20% of said carbon atoms being bonded with distorted tetrahedral coordination.

5. The surface of claim 1, wherein the diamond-like carbon layer includes at least about 80% carbon atoms with at least about 20% of said carbon atoms being bonded with distorted tetrahedral coordination.

6. The surface of claim 1, wherein the diamond-like carbon layer has a thickness of from about 10 nanometers to about 1 microns.

7. The surface of claim 1, wherein the diamond-like carbon layer has a thickness of less than about 500 nanometers.

8. The surface of claim 1, wherein the diamond-like carbon layer has a thickness of less than about 200 nanometers.

9. The surface of claim 2, wherein the array of electrically coupled metal cones have a tip to tip spacing distance of less than about 10 microns.

10. The surface of claim 2, wherein the array of electrically coupled metal cones have a tip to tip height variation of less than about 20% of the tip to tip spacing distance average.

11. The method of claim 1, wherein the at least one metal cone is formed of a member selected from the group consisting of Ni, Mo, Cu, Zn, Pd, Ag, W, Ta, Pt, Au, Ti, Fe, Co, Cr, and alloys and combinations thereof.

12. The method of claim 1, wherein the at least one metal cone is formed of a member selected from the group consisting of Ni, Mo, Cu, Ag, W, Cr, and alloys and combinations thereof.

13. The method of claim 1, wherein the at least one metal cone is formed of Ni.

14. The method of claim 1, wherein the at least one metal cone is formed of W.

15. A device for detection of infrared photons, comprising:
a first electrode electrically coupled to the infrared photon detection surface as recited in claim 2; and
a second electrode positioned adjacent to and facing the infrared photon detection surface.

16. The device of claim 15, further comprising infrared photon detection circuitry to register electron flow due to infrared photon detection.

17. The device of claim 15, wherein the first electrode is a cathode and the second electrode is an anode.

18. The device of claim 15, wherein a vacuum is present between the first electrode and the second electrode.

19. The device of claim 15, further including an intermediate member electrically coupled to and located in between the first electrode and the second electrode, said intermediate member including a dielectric material and is capable of supporting a voltage from about 0.1 V to about 6 V across the intermediate member.

20. The device of claim 19, wherein the intermediate member has a thermal conductivity less than about 200 W/mK.

21. The device of claim 19, wherein the intermediate member has a thickness from about 0.2 μm to about 100 μm.

22. The device of claim 19, wherein the dielectric material is a polymer, a glass, a ceramic, graphite, or a mixture or composite thereof.

23. The device of claim 19, wherein the dielectric material is a member selected from the group consisting of BaTiO₃, PZT, Ta₂O₃, PET, PbZrO₃, PbTiO₃, NaCl, LiF, MgO, TiO₂, Al₂O₃, BaO, KCl, Mg₂SO₄, fused silica glass, soda lime silica glass, high lead glass, graphite, hexagonal boron nitride, and mixtures or combinations thereof.

24. The device of claim 19, wherein the dielectric material comprises graphite and hexagonal boron nitride.

25. The device of claim 15, further comprising a plurality of electrically isolated infrared photon detection surfaces, wherein each of the plurality of electrically isolated infrared photon detection surfaces is electrically coupled to one of a plurality of electrically isolated first electrodes.

26. A method of making a device for detection of infrared photons, comprising:
electrically coupling a first electrode to the array of diamond-like carbon coated electrically coupled metal cones of claim 2 such that the metal cones project from the first electrode; and
positioning a second electrode adjacent to and facing the metal cones, thus forming a gap between the first electrode and the second electrode.

27. The method of claim 26, wherein positioning the second electrode adjacent to and facing the metal cones further includes fixing the second electrode relative to the first electrode to maintain the gap.

28. The method of claim 27, further comprising:
sealing the gap around edges of the first and second electrodes; and
applying a vacuum in the gap.

29. The method of claim 26, where positioning a second electrode adjacent to and facing the metal cones further comprises:
forming an intermediate member on the array of electrically coupled metal cones, said intermediate member including a dielectric material that is capable of supporting a voltage from about 0.1 V to about 6 V across the intermediate member; and
coupling the second electrode to the intermediate member opposite the cathode.
